(19) United States
(12) Patent Application Publication
(10) Pub. No.: US 2026/0120717 A1
(43) Pub. Date: Apr. 30, 2026

(54) METHOD

(71) Applicant: TOYOTA JIDOSHA KABUSHIKI KAISHA, Toyota-shi (JP)

(72) Inventors: Yukiko SONOHARA, Obu-shi (JP); Hirofumi MORISHITA, Anjo-shi (JP)

(73) Assignee: TOYOTA JIDOSHA KABUSHIKI KAISHA, Toyota-shi (JP)

(21) Appl. No.: 19/368,014

(22) Filed: Oct. 24, 2025

(30) Foreign Application Priority Data
Oct. 28, 2024 (JP) 2024-189205

(51) Int. Cl. G11B 20/10; G06Q 10/10; G06Q 30/02; G06V 40/10; G10L 15/22

(52) U.S. Cl. CPC G11B 20/10527; G06Q 10/10; G06Q 30/0281; G06V 40/103; G10L 15/22; G11B 2020/10546

(57) ABSTRACT

A method executed by an information processing apparatus that includes a controller, an imager, and an input interface includes executing, by the controller, operations including acquiring consent from a customer regarding recording of customer engagement audio via the input interface, starting audio recording after the consent is acquired, detecting a staff member from an image of the imager, and interrupting the audio recording in a case in which a predetermined condition is met, and the predetermined condition includes a first condition that the staff member has disappeared from the image of the imager.

### CROSS-REFERENCE TO RELATED APPLICATION

This application claims priority to Japanese Patent Application No. 2024-189205 filed on Oct. 28, 2024, the entire contents of which are incorporated herein by reference.

### TECHNICAL FIELD

The present disclosure relates to a method.

### BACKGROUND

Technology for analyzing dialogue content is known. For example, Patent Literature (PTL) 1 discloses a dialogue analysis system that records dialogue data based on audio data of recorded dialogue content and extracts dialogues that match conditions specified by the user from the dialogue data to display a list thereof.

### CITATION LIST

### Patent Literature

PTL 1: JP 2019-028910 A

### SUMMARY

Store staff record audio during customer engagement such as sales talks and utilize the recorded audio for purposes such as creating customer reports. The staff may temporarily leave their seats for tasks such as preparing estimates and contract documents. It is desirable that the audio recording is interrupted while the staff are away from their seats. However, the staff may forget to perform the operation to interrupt the audio recording due to concentrating on the customer engagement.

It would be helpful to improve technology for analyzing dialogue content.

A method according to an embodiment of the present disclosure is a method executed by an information processing apparatus that includes a controller, an imager, and an input interface, the method including executing, by the controller, operations including:
acquiring consent from a customer regarding recording of customer engagement audio via the input interface;
starting audio recording after the consent is acquired;
detecting a staff member from an image of the imager; and
interrupting the audio recording in a case in which a predetermined condition is met,
wherein the predetermined condition includes a first condition that the staff member has disappeared from the image of the imager.

According to an embodiment of the present disclosure, technology for analyzing dialogue content is improved.

### BRIEF DESCRIPTION OF THE DRAWINGS

In the accompanying drawings:

FIG. 1 is a block diagram illustrating a schematic configuration of an information processing apparatus according to an embodiment of the present disclosure; and

FIG. 2 is a flowchart illustrating operations of the information processing apparatus according to an embodiment of the present disclosure.

### DETAILED DESCRIPTION

Embodiments of the present disclosure will be described below, with reference to the drawings.

### Outline of Present Embodiment

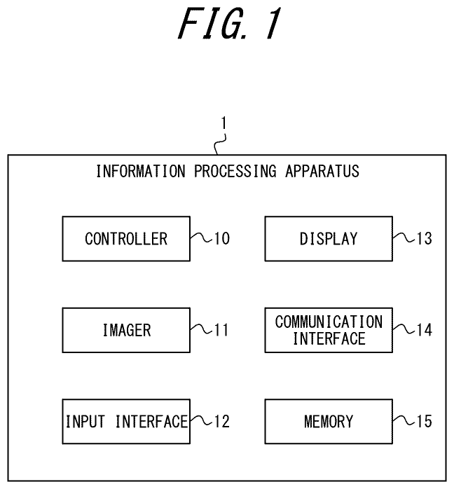

With reference to FIG. 1, an overview of the information processing apparatus 1 according to the embodiment of the present disclosure will be described. In this embodiment, the information processing apparatus 1 is a computer such as a laptop or tablet. The information processing apparatus 1 is used, for example, by staff in a store. The information processing apparatus 1 is capable of recording the voices of customers and staff.

First, an outline of the present embodiment will be described, and details will be described later. The method according to the present embodiment is executed by the information processing apparatus 1, which includes a controller 10, an imager 11, and an input interface 12. The controller 10 acquires consent from a customer regarding recording of customer engagement audio via the input interface 12. The controller 10 starts audio recording after the consent is acquired. The controller 10 detects a staff member from the images of the imager 11. The controller 10 interrupts the audio recording in a case in which a predetermined condition is met. The predetermined condition includes a first condition that the staff member has disappeared from the images of the imager 11.

According to this embodiment, if the predetermined condition is met, the recording is automatically interrupted. As a result, the recording is reliably interrupted without the staff needing to perform the interruption operation.

### (Configuration of Information Processing Apparatus 1)

As illustrated in FIG. 1, the information processing apparatus 1 includes a controller 10, an imager 11, an input interface 12, a display 13, a communication interface 14, and a memory 15.

The controller 10 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 10 executes various processes related to the operations of the information processing apparatus 1 and controls the components of the information processing apparatus 1.

The imager 11 includes any imaging module capable of capturing the surroundings of the information processing apparatus 1. The imaging module includes one or more cameras. Each camera is arranged at a suitable position of the information processing apparatus 1 so that it can capture the surroundings of the information processing apparatus 1. In this embodiment, the imager 11 includes an in-camera capable of capturing the subject (for example, staff) on the user side of the information processing apparatus 1. The imager 11 may further include an out-camera capable of capturing the subject (for example, customers) on the opposite side of the user.

The input interface 12 is equipped with one or more input interfaces. The input interface includes a microphone for receiving voice input from customers and staff. The input interface may include, for example, a physical key, a capacitive key, a pointing device, or a touch screen integrally provided with the display of the display 13. The input interface 12 accepts an operation for inputting information to be used for the operations of the information processing apparatus 1. The input interface 12 may be connected to the information processing apparatus 1 as an external input device, instead of being included in the information processing apparatus 1. As a connection method, any method such as Universal Serial Bus (USB), High-Definition Multimedia Interface (HDMI® (HDMI is a registered trademark in Japan, other countries, or both)), or Bluetooth® (Bluetooth is a registered trademark in Japan, other countries, or both) can be used.

The display 13 includes one or more display interfaces. The display interface is, for example, a display that shows information as an image. The display is, for example, a liquid crystal display (LCD) or an organic electro-luminescent (EL) display. The display 13 displays information obtained by the operations of the information processing apparatus 1. The display 13 may be connected to the information processing apparatus 1 as an external display device, instead of being included in the information processing apparatus 1. As a connection method, any method such as USB, HDMI®, or Bluetooth® can be used.

The communication interface 14 includes at least one interface for communication to connect to a network. The communication interface is compliant with mobile communication standards such as the 4th generation (4G) standard and the 5th generation (5G) standard, or wired local area network (LAN) communication standards or wireless LAN communication standards, for example, but is not limited to these and may be compliant with any communication standard.

The memory 15 includes one or more memories. The memories included in the memory 15 may each function as, for example, a main memory, an auxiliary memory, or a cache memory. The memory 15 stores any information to be used for operations of the information processing apparatus 1. The memory 15 may store, for example, a system program, an application program, and embedded software. In this embodiment, the memory 15 may store any data related to customer engagement such as sales talks. The information stored in the memory 15 may be updated based on information acquired from the network via the communication interface 14.

### (Flow of Operations of Information Processing Apparatus 1)

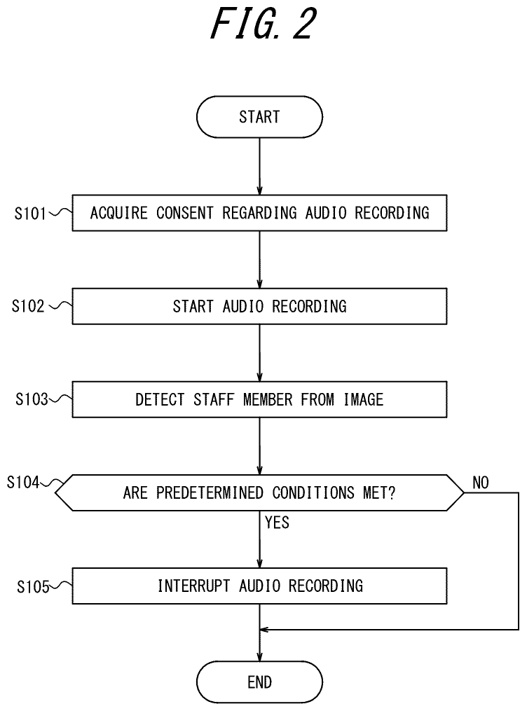

Operations of the information processing apparatus 1 according to the present embodiment will be described with reference to FIG. 2. In the following, communication between the respective parts of the information processing apparatus 1 is performed via the communication interface 14.

S101: The controller 10 of the information processing apparatus 1 acquires consent from a customer regarding recording of customer engagement audio via the input interface 12.

In this embodiment, the controller 10 acquires consent by detecting a consent phrase indicating the customer's consent regarding recording from the utterance input to the input interface 12 (for example, a microphone). The controller 10 may detect the consent phrase by comparing the phrases stored in the memory 15 with the phrases included in the utterance content. The comparison may utilize natural language processing techniques such as morphological analysis, syntactic analysis, semantic analysis, contextual analysis, and co-reference analysis, along with a pre-trained machine learning model. The learning model may be trained to take the utterance content as input and output the comparison results between the phrases stored in the memory 15 and the phrases included in the utterance content. The features of the learning model may include specific words or phrases, such as “recording” or “consent.”

The consent phrase may include phrases indicating consent to the recording of customer engagement audio, such as “I consent to the recording of customer engagement audio.” The consent phrase may include staff questions regarding consent and the customer's responses to those questions, such as “Do you consent to the recording of customer engagement audio?” and “Yes.” The consent phrase is not limited to the above examples and may include any phrase.

The controller 10 may display the question on the display interface 13 to prompt the staff to utter the question. This allows the staff to ensure that they ask the consent-related question even if they forget to ask or forget the content of the question, thereby reliably obtaining consent.

The controller 10 may acquire consent by obtaining the customer's signature input on the input interface 12 (for example, a touch screen). Alternatively, the controller 10 may display a screen requesting consent on the display interface 13 and acquire consent by accepting the customer's selection of consent via the input interface 12 (for example, selecting a button indicating consent).

S102: The controller 10 starts recording after the consent is acquired.

Specifically, the controller 10 records the voices of the staff and the customer input to the microphone of the input interface 12.

S103: The controller 10 detects the staff member from the images of the imager 11.

The image may be captured by the imager 11, for example, the front camera. Alternatively, the controller 10 may detect the customer from the image of the imager 11. The image may be captured by the imager 11, for example, the rear camera. The controller 10 may detect the staff or customer from the image using any object detection technology such as You Only Look Once (YOLO) and a convolutional neural network (CNN).

S104: The controller 10 determines whether the predetermined condition is met. If the predetermined condition is met (S104—YES), the process proceeds to S105. If the predetermined condition is not met, the process ends.

In this embodiment, the predetermined condition includes a first condition that the staff has disappeared from the image of the imager 11 (for example, the front camera). If the controller 10 is detecting the customer from the image in S103, alternatively, the first condition may be a condition that the customer has disappeared from the image of the imager 11 (for example, the rear camera). Thus, recording can be interrupted even when the customer leaves their seat. The controller 10 may determine the disappearance of the staff or customer from the image using any object detection technology such as YOLO and CNN.

The predetermined condition may include, in addition to or instead of the first condition, a second condition that a leaving phrase suggesting the customer leaving their seat has been detected from the utterance input to the input interface 12. The process may proceed to S105 if either the first condition and the second condition are met, or only the second condition is met. If the predetermined condition includes only the second condition, S103 may not be executed.

The leaving phrase may be pre-stored in the memory 15. The controller 10 may detect the leaving phrase by comparing the phrases stored in the memory 15 with the phrases included in the utterance content. The comparison may utilize natural language processing techniques such as morphological analysis, syntactic analysis, semantic analysis, contextual analysis, and co-reference analysis, along with a pre-trained machine learning model. The learning model may be trained to take the utterance content as input and output the comparison results between the phrases stored in the memory 15 and the phrases included in the utterance content. The features of the learning model may be specific words or phrases, for example, “I will be leaving.”

The leaving phrase may include phrases that are likely to be spoken by the staff or customer when leaving, such as “I apologize, but I will be leaving,” or “I will be looking around the store.” By setting such phrases as leaving phrases, it ensures that the interruption is executed even if the staff forgets to perform the interruption operation. The leaving phrase is not limited to the above example and may include any phrase.

S105: The controller 10 interrupts the audio recording. The process then ends.

The controller 10 may resume the audio recording after interrupting it if a staff member or customer is detected from the image of the imager 11 (for example, the front camera or rear camera).

The controller 10 may be in a state where it can acquire audio in the background from the input interface 12 after interrupting the audio recording. While acquiring audio in the background, the controller 10 does not perform recording. Furthermore, the controller 10 may resume the audio recording if a return phrase suggesting that a staff member or customer has returned is detected from the utterance inputted to the input interface 12.

The return phrase may include phrases that are likely to be spoken by the staff or customer upon their return, such as “I have just returned.” By setting such phrases as return phrases, it ensures that the resumption is executed even if the staff forgets to perform the resumption operation. The return phrase is not limited to the above example and may include any phrase.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, an embodiment in which the configuration and operations of the information processing apparatus 1 are distributed to multiple computers capable of communicating with each other can be implemented. For example, the configuration and operations of the information processing apparatus 1 may be distributed between a server apparatus and one or more terminal apparatuses.

1. A method executed by an information processing apparatus that includes a controller, an imager, and an input interface, the method comprising executing, by the controller, operations including:
acquiring consent from a customer regarding recording of customer engagement audio via the input interface;
starting audio recording after the consent is acquired;
detecting a staff member from an image of the imager; and
interrupting the audio recording in a case in which a predetermined condition is met,
wherein the predetermined condition includes a first condition that the staff member has disappeared from the image of the imager.

2. The method according to claim 1, wherein the operations further include resuming the audio recording in a case in which the staff member has been detected from the image of the imager after the audio recording has been interrupted.

3. The method according to claim 1, wherein the predetermined condition further includes a second condition that a leaving phrase suggesting the customer leaving their seat has been detected from an utterance input to the input interface.

4. The method according to claim 3, wherein the operations further include:
making the controller be capable of acquiring audio in background from the input interface after the audio recording has been interrupted; and
resuming the audio recording in a case in which a return phrase suggesting the customer having returned has been detected from the utterance input to the input interface.

5. The method according to claim 1, wherein the acquiring of the consent includes detecting a consent phrase suggesting the consent from an utterance input to the input interface.
